(19) United States
(12) Patent Application Publication
(10) Pub. No.: US 2015/0184302 A1
(43) Pub. Date: Jul. 2, 2015

(54) TIN-PLATED COPPER-ALLOY TERMINAL MATERIAL

(71) Applicant: MITSUBISHI MATERIALS CORPORATION, Tokyo (JP)

(72) Inventors: Yuki Inoue, Naka-shi (JP); Naoki Kato, Tokyo (JP); Kiyotaka Nakaya, Naka-shi (JP)

(21) Appl. No.: 14/560,467

(22) Filed: Dec. 4, 2014

(30) Foreign Application Priority Data
Dec. 27, 2013 (JP) 2013-271703
Oct. 15, 2014 (JP) 2014-210658

(51) Int. Cl. C23C 28/02; H01B 1/02

(52) U.S. Cl. CPC C23C 28/021; H01B 1/02; H01B 1/026

(57) ABSTRACT

By forming a nickel-based coating layer or a cobalt-based coating layer having a coating thickness of 0.005 μm or larger and 0.05 μm or smaller on an outermost surface of a tin-based surface layer of a terminal material of low-insertion force in which an asperity shape of an interface between a copper-tin alloy layer and a tin-based surface layer is controlled, it is possible to reduce insertion force of fitting even though all-purpose tin-plated terminal material is used by combination.

### BACKGROUND OF THE INVENTION

1. Field of the Invention

The present invention relates to tin-plated copper-alloy terminal material that is useful for a terminal for a connector used for connecting electrical wiring of automobiles or personal products, and in particular, which is useful for a terminal for a multi-pin connector.

Priority is claimed on Japanese Patent Application No. 2013-271703, filed Dec. 27, 2013, and Japanese Patent Application No. 2014-210658, filed Oct. 15, 2014, the content of which is incorporated herein by reference.

2. Description of Related Art

Tin-plated copper-alloy terminal material is formed by reflowing after copper (Cu) plating and tin (Sn) plating on base material made of copper alloy so as to have a tin-based surface layer as a surface layer and a copper-tin (Cu—Sn) alloy layer as a bottom layer, and is widely used as material for terminal.

In recent years, for example, electrification is rapidly progressed in vehicle and circuits are increased in electrical equipment, so that connector used in the circuit is remarkably downsized and the pins thereof are increased. When the connector have a lot of pins, even though a force for inserting the connector for a pin is small, a large force is required for inserting the connector for all pins; therefore, it is apprehended that productivity is deteriorated. Accordingly, it is attempted to reduce the force for inserting a pin by reducing the friction coefficient of tin-plated copper-alloy material.

For example, in Patent Document 1 (Japanese Unexamined Patent Application, First Publication No. H11-102739), it is described that tin-plated copper-alloy material in which a metal layer having a crystalline structure which is differ from that of tin on an outermost surface thereof is formed so as to reduce the insertion force; nevertheless there are problems that contact resistance is increased, or soldering wettability is deteriorated.

In Patent Document 2 (Japanese Unexamined Patent Application, First Publication No. 2007-177329), it is described that a surface-plating layer is made by reflowing or thermal diffusion of a tin-plating layer and a plating layer containing silver (Ag) or indium (In).

In Patent Document 3 (Japanese Unexamined Patent Application, First Publication No. 2004-225070), it is described that a silver-tin (Sn—Ag) alloy layer is made by forming a silver-plating layer on a tin-plating layer and then heat treating.

Such techniques as in Patent Documents 2 and 3 take a high cost since an entire surface is plated with silver-tin alloy, silver, and the like.

Insertion force “F” of a connector is obtained as “F=2×μ×P” when “P” is a pressure force of a female terminal pressing a male terminal and “μ” is a dynamic friction coefficient, since the male terminal is held between the two female terminals. In order to reduce the insertion force “F”, it is effective to reduce the pressure force “P”. However, the pressure force cannot be reduced enough for maintaining electrical-connection reliability of the male-female terminals while being engaged; at least 3 N is necessary for the pressure force “P”. In multi-pin connectors, even though there is a case in which one connector has 50 pins or more, it is desirable for the insertion force of an entire connector to be 100 N or lower, if possible, 80 N or lower, or 70 N or lower, so that it is required for the dynamic friction coefficient “μ” to be 0.3 or lower.

### SUMMARY OF THE INVENTION

### Problems to be Solved by the Invention

Conventionally, tin-plated material in which frictional resistance at a surface layer is reduced is developed; in many cases, it is effective to reduce the frictional resistance between the same kinds of tin-plated material. However, in connecting terminals in which the male and female terminals are engaged, actually there are not many cases that the male and female terminals are made from the same material; particularly for the male terminal, all-purpose tin-plated terminal material made of brass as base material is widely used. Therefore, there is a problem that effect of reducing the insertion force is small even if only the female terminal is made of terminal material of low-insertion force.

The present invention is achieved in consideration of the above circumstances, and has an object to provide tin-plated copper-alloy terminal material in which an insertion force for fitting can be reduced also for terminals made of all-purpose tin-plated terminal material.

### Means for Solving the Problem

The inventors found a means to reduce frictional resistance at a surface layer of terminal material; that is, a friction coefficient was reduced by controlling a shape of an interface between a copper-tin alloy layer and a tin-based surface layer and arranging the copper-tin alloy layer having precipitous asperity directly under the tin-based surface layer. However, if this terminal material of low-insertion force is used for only one of the terminals and the other is made of all-purpose tin-plated material, reduction effect of the friction coefficient was reduced by half.

Since both uppermost surfaces are tin-plated, the reduction effect of the friction coefficient is decreased by half by adhesion of tin owing to contact of tin with each other of the same kind. Particularly, it is supposed that in the terminal material of low-insertion force, the adhesion occurs by shaving tin at the soft tin-plated layer of the all-purpose tin-plated terminal material since the hard copper-tin alloy layer is arranged directly under the tin-based surface layer.

The inventors found by intensive research that by forming a thin nickel-plating (Ni) or a thin cobalt-plating (Co) on an uppermost surface, the reduction effect of the friction coefficient of the terminal material of low-insertion force can be maintained, the adhesion of tin can be restrained, and it is possible to reduce the frictional resistance even if the other terminal is made of all-purpose material.

According to the present invention, a tin-plated copper-alloy terminal material includes: a base material which is made of copper or copper alloy; a tin-based surface layer which is formed on a surface of the base material and has an average thickness of 0.2 μm or larger and 0.6 μm or smaller; a nickel-based coating layer or a cobalt-based coating layer which is formed on an outermost surface of the tin-based surface layer and has a coating thickness of 0.005 μm or larger and 0.05 μm or smaller; and a copper-tin alloy layer/a nickel-tin alloy layer/a nickel layer or a nickel-alloy layer which are formed between the tin-based surface layer and the base material in order from the tin-based surface layer, the tin-plated copper-alloy terminal material in which: the copper-tin alloy layer is a compound-alloy layer in which a major ingredient is Cu₆Sn₅ and a part of copper of Cu₆Sn₅ is substituted by nickel; the nickel-tin alloy layer is a compound-alloy layer in which a major ingredient is Ni₃Sn₄ and a part of nickel of Ni₃Sn₄ is substituted by copper; an average gap “S” of point peaks of the copper-tin alloy layer is 0.8 μm or larger and 2.0 μm or smaller; and a dynamic friction coefficient at a surface of the tin-plated copper-alloy terminal material is 0.3 or lower.

The dynamic friction coefficient can be 0.3 or lower with respect to the all-purpose tin-plated terminal material by setting the average gap “S” between the point peaks of the copper-tin alloy layer to 0.8 μm or larger and 2.0 μm or smaller, setting the average thickness of the tin-based surface layer to 0.2 μm or larger and 0.6 μm or smaller, and providing the nickel-based coating layer or the cobalt-based coating layer on the outermost surface of the tin-based surface layer with 0.005 μm or larger and 0.05 μm or smaller. In this case, since the layer of (Cu, Ni)₆Sn₅ (i.e., the copper-tin alloy layer) in which the part of copper is substituted by nickel and the layer of (Ni, Cu)₃Sn₄ (i.e., the nickel-tin alloy layer) in which the part of nickel is substituted by copper exist, the copper-tin alloy layer has a precipitous asperity in which the average gap “S” between the point peaks is 0.8 μm or larger and 2.0 μm or smaller. The average thickness of the tin-based surface layer is set to 0.2 μm or larger and 0.6 μm or smaller: because if it is smaller than 0.2 μm, soldering wettability and electrical-connection reliability are deteriorated; or if it is larger than 0.6 μm, a surface layer is not formed to have composite construction of tin and copper-tin alloy, so that the dynamic friction coefficient is increased since the surface layer is occupied by tin. More preferably, the average thickness of the tin-based surface layer is 0.3 μm or larger and 0.5 μm or smaller.

The reduction effect of the friction coefficient can be higher at the nickel-based coating layer or the cobalt-based coating layer at the outermost surface than at the copper-tin alloy layer since the adhesion with tin is less likely to occur. In this case, if coating thickness of the nickel-based coating layer or the cobalt-based coating layer exceeds 0.05 μm, the reduction effect of friction coefficient by a peculiar shape of an interface between the tin-based surface layer and the copper-tin alloy layer and restraint effect of tin-adhesion by the nickel-based coating layer or the cobalt-based coating layer cannot be obtained at the same time; accordingly, the reduction effect of friction coefficient cannot be obtained enough since only the restraint effect of the adhesion by the nickel-based coating layer or the cobalt-based coating layer functions; and the soldering wettability may be deteriorated. If the coating thickness of the nickel-based coating layer or the cobalt-based coating layer is smaller than 0.005 μm, the effect thereof cannot be obtained.

The dynamic friction coefficient at the surface is 0.3 or lower between the tin-plated copper-alloy terminal material of the present invention, naturally; and it is also 0.3 or lower with respect to the all-purpose tin-plated terminal material having a tin-plating layer on an outermost surface. The all-purpose tin-plated terminal material having the tin-plating layer on the outermost is: a tin-plated terminal material in which an average gap “S” between point peaks of a copper-tin alloy layer is smaller than 0.8 μm or larger than 2.0 μm and in which a tin-plating layer with an average thickness of 0.2 μm or larger and 3 μm or smaller is formed on the outermost surface; or a tin-plated terminal material in which a tin-plating layer with a thickness of 0.5 μm or larger and 3 μm or smaller is formed on a base material without reflowing. The all-purpose tin-plated terminal material having the tin-plating layer on the outermost can be obtained by copper plating, tin plating and then reflowing on a base material.

In the tin-plated copper-alloy terminal material of the present invention, a part of copper-tin alloy layer may be exposed from the tin-based surface layer, and the nickel-based coating layer or the cobalt-based coating layer may be formed on the copper-tin alloy layer which is exposed from the tin-based surface layer.

In order to maintain the nickel-based coating layer or the cobalt-based coating layer by the hard copper-tin alloy layer exposed on a surface of the tin-based surface layer, the nickel-based coating layer or the cobalt-based coating layer is formed on the copper-tin alloy layer. If it is not formed on the copper-tin alloy layer and is formed only on the tin-based surface layer, the nickel-based coating layer or the cobalt-based coating layer is broken when the terminal materials are rubbed each other; as a result, adhesion of tin occurs by contacting the same kind of tin to each other, the reduction effect of the friction coefficient cannot be obtained. The nickel-based coating layer or the cobalt-based coating layer is necessary to be formed at least on the copper-tin alloy layer; and may be formed on the tin-based surface layer.

In the tin-plated copper-alloy terminal material of the present invention, the copper-tin alloy layer may contain 1 at % or more and 25 at % or less of nickel in Cu₆Sn₅.

The nickel content is defined to 1 at % or more, because if it is less than 1 at %, the compound-alloy layer in which the part of copper in Cu₆Sn₅ is substituted by nickel cannot be formed so the precipitous asperity cannot obtained. The nickel content is defined to 25 at % or less, because if it exceeds 25 at %, a shape of the copper-tin alloy layer is too fine, so that there is a case in which the dynamic friction coefficient cannot be reduced to 0.3 or lower.

### Effects of the Invention

According to the present invention, by forming a nickel-based coating layer or a cobalt-based coating layer having a coating thickness of 0.005 μm or larger and 0.05 μm or smaller on an outermost surface of a tin-based surface layer of a terminal material of low-insertion force in which an asperity shape of an interface between a copper-tin alloy layer and a tin-based surface layer is controlled, it is possible to reduce insertion force of fitting even though all-purpose tin-plated terminal material is used by combination.

### BRIEF DESCRIPTION OF THE DRAWINGS

FIG. 1 is a cross sectional view schematically showing tin-plated copper-alloy terminal material according to the present invention.

FIG. 2 is a cross sectional view of a fitting part showing an example of a fitting-connection terminal in which terminal material of the present invention is applied.

FIG. 3 is a cross-sectional view schematically showing terminal material used for a male terminal.

FIG. 4 is a frontal view conceptually showing a device for measuring dynamic friction coefficient.

FIG. 5 is an image by a STEM (a scanning transmission electron microscope) of a cross section of copper-alloy terminal material of Example 6.

FIG. 6 is an analysis diagram by an EDS (an Energy Dispersive X-ray Spectrometry) along the white line in FIG. 5.

FIG. 7 is an image by a STEM of a cross section of copper-alloy terminal material of Comparative Example 7.

FIG. 8 is an analysis diagram by an EDS along the white line in FIG. 7.

FIG. 9 is a photomicrograph showing a surface of a test piece of a male terminal of Example 2 after measuring dynamic friction coefficient.

FIG. 10 is a photomicrograph showing a surface of a test piece of a male terminal of Comparative Example 1 after measuring dynamic friction coefficient.

FIG. 11 is a photomicrograph showing a surface of a test piece of a male terminal of Comparative Example 3 after measuring dynamic friction coefficient.

FIG. 12 is a photomicrograph showing a surface of a test piece of a male terminal of Example 24 after measuring dynamic friction coefficient.

FIG. 13 is a photomicrograph showing a surface of a test piece of a male terminal of Comparative Example 13 after measuring dynamic friction coefficient.

### DESCRIPTION OF THE PREFERRED EMBODIMENTS

An embodiment of tin-plated copper-alloy terminal material according to the present invention will be described.

As schematically shown in FIG. 1, in this tin-plated copper-alloy terminal material according to the present embodiment: a tin-based surface layer 6 is formed on a surface of a base material 5 made of copper or copper alloy; a copper-tin alloy layer 7/a nickel-tin alloy layer 8/a nickel-or-nickel-alloy layer 9 are formed between the tin-based surface layer 6 and the base material 5 in order from the tin-based surface layer 6; and a nickel-based coating layer 10 with a coating thickness of 0.005 μm or larger and 0.05 μm or smaller on the tin-based surface layer 6. Dynamic friction coefficient of a surface of the tin-plated copper-alloy terminal material is 0.3 or lower.

In this case, the copper-tin alloy layer 7 is partially exposed from the tin-based surface layer 6. The nickel-based coating layer 10 is formed on exposed portions of the copper-tin alloy layer 7 exposed from the tin-based surface layer 6 or a region including the exposed portions of the copper-tin alloy layer 7 and the vicinity thereof in the tin-based surface layer 6.

The base material 5 is made of copper or copper alloy, and is not limited to a specific composition.

The nickel-or-nickel-alloy layer 9 is a layer made of pure nickel or nickel alloy such as nickel-cobalt (Ni—Co), nickel-tungsten (Ni—W) or the like.

The copper-tin alloy layer 7 is a compound-alloy layer in which a major ingredient is Cu₆Sn₅ and a part of copper of Cu₆Sn₅ is substituted by nickel. The nickel-tin alloy layer 8 is a compound alloy layer in which a major ingredient is Ni₃Sn₄ and a part of nickel of Ni₃Sn₄ is substituted by copper. Those compound layers are formed by forming a nickel-plating layer, a copper-plating layer, and a tin-plating layer in order on the base material 5 and then reflowing, on the nickel-or-nickel-alloy layer 9 in order of the nickel-tin alloy layer 8, and the copper-tin alloy layer 7.

An interface between the copper-tin alloy layer 7 and the tin-based surface layer 6 is formed as precipitous asperity so that an average gap “S” of point peaks of the copper-tin alloy layer 7 is 0.8 μm or larger and 2.0 μm or smaller. The average gap “S” of the point peaks is an average value of distances between the point peaks in a sampling length. The distances between the point peaks are obtained by selecting a roughness curve with the sampling length along a mean line of the roughness curve, and measuring lengths of the mean line corresponding to the point peaks adjacent to each other. The roughness curve can be obtained by detecting a surface of the copper-tin alloy layer 7 after removing the nickel-based coating layer 10 and the tin-based surface layer 6 by etchant.

An average thickness of the tin-based surface layer 6 is 0.2 μm or larger and 0.6 μm or smaller. On an outermost surface of the tin-based surface layer 6, the nickel-based coating layer 10 is formed to have thickness of 0.005 μm or larger and 0.05 μm or smaller.

In the terminal material having the above structure, since a layer of (Ni, Cu)₃Sn₄ (i.e., the nickel-tin alloy layer 8) in which the part of nickel is substituted by copper exists under a layer of (Cu, Ni)₆Sn₅ (i.e., the copper-tin alloy layer 7) in which the part of copper is substituted by nickel, the average gap “S” between the point peaks of the copper-tin alloy layer 7 is 0.8 μm or larger and 2.0 μm or smaller so that the precipitous asperity is formed. Accordingly, the terminal material has a composite structure of the hard copper-tin alloy layer 7 and the tin-based surface layer 6 in a depth range of several hundred nm from the surface of the tin-based surface layer 6.

In this case, nickel content of Cu₆Sn₅ is 1 at % or more and 25 at % or less. Since the compound-alloy layer in which the part of copper in Cu₆Sn₅ is substituted by nickel is not formed if the nickel content is less than 1 at %, the precipitous asperity cannot be formed, so that it is defined 1 at % or more. If the nickel content exceeds 25 at %, the shape of the copper-tin alloy layer 7 may be excessively fine. When the copper-tin alloy layer 7 is excessively fine, there is a case in which the dynamic friction coefficient cannot be reduced to 0.3 or lower, so that the nickel content is defined to 25 at % or less.

Meanwhile, a preferred copper content of a Ni₃Sn₄ alloy layer is 5 at % or more and 20 at % or less. The less copper content is a condition in which the nickel content of Cu₆Sn₅ is also reduced (since if copper is not substituted in Ni₃Sn₄, less nickel is substituted in Cu₆Sn₅), so that the precipitous asperity cannot be obtained. An upper limit is defined since an excess copper over 20% cannot be practically contained in Ni₃Sn₄.

A part of the copper-tin alloy layer 7 (Cu₆Sn₅) is exposed from the tin-based surface layer 6. In this case, the exposed portions each have an equivalent-circle diameter of 0.6 μm or larger and 2.0 μm or smaller and an exposed-area rate of 10% or more and 40% or less. In this limited extent, an excellent electrical-connection characteristic of the tin-based surface layer 6 is not deteriorated.

The average thickness of the tin-based surface layer 6 is defined to 0.2 μm or larger and 0.6 μm or smaller since: if it is smaller than 0.2 μm, the soldering wettability and the electrical-connection reliability are deteriorated; and if it exceeds 0.6 μm the surface layer is not the composite structure of tin and copper-tin alloy and occupied only by tin, so that the dynamic friction coefficient is increased. More preferably, the average thickness of the tin-based surface layer 6 is 0.3 μm or larger and 0.5 μm or smaller.

The nickel-based coating layer 10 is a coating layer made from nickel or nickel alloy (nickel-tin alloy), and is formed on the tin-based surface layer 6 after reflowing with a coating thickness of 0.005 μm or larger and 0.05 μm or smaller as mentioned below.

However, the nickel-based coating 10 layer is not formed on the entire uppermost surface, but formed mainly on the exposed portions of the copper-tin alloy layer 7 exposed from the tin-based surface layer 6. Accordingly, the uppermost surface is a surface in which the tin-based surface layer 6 and the nickel-based coating layer 10 are mixed. In this case, the tin-based surface layer 6 is studded with the exposed portions of the copper-tin alloy layer 7. The exposed portions of the copper-tin alloy layer 7 are almost coated by the nickel-based coating layer 10; however, it is not required to be fully coated by the nickel-based coating layer 10. Some of the exposed portions may remain without being coated by the nickel-based coating layer 10 in an exposed state.

If the nickel-based coating layer 10 is not formed on the exposed portions of the copper-tin alloy layer 7 and formed only on the tin-based surface layer 6, in an early stage of using as a connector, the nickel-based coating layer 10 is broken by abrasion between the terminal materials. As a result, adhesion of tin owing to contact of tin of the same kind with each other may occur, so that it is difficult to maintain the reduction effect of the friction coefficient.

If the coating thickness of the nickel-based coating layer 10 exceeds 0.05 μm, it is not possible to obtain the reduction effect of friction coefficient by the specific shape of the interface between the tin-based surface layer 6 and the copper-tin alloy layer 7 along with restriction effect of adhesion of tin by the nickel-based coating layer 10 at the same time, so that the reduction effect of friction coefficient is not enough and the soldering wettability is deteriorated since only the restriction effect of adhesion of tin by the nickel-based coating layer 10 is obtained. The effect cannot be obtained if the coating thickness of the nickel-based layer 10 is smaller than 0.005 μm.

A manufacturing method of the terminal material will be described.

As a base material, a plate material made of copper or copper alloy such as copper-nickel-silicon based (Cu—Ni—Si) is prepared. A surface of the plate material is purified by degreasing, acid cleaning and the like, and then undercoat-nickel plating, copper plating, and tin plating are carried out in order.

In undercoat-nickel plating, an ordinary nickel-plating bath can be used; for example, a sulfate bath containing sulfate acid (H₂SO₄) and nickel sulfate (NiSO₄) as major ingredients can be used. Temperature of the plating bath is set to 20° C. or higher and 50° C. or lower; and current density is set 1 to 30 A/dm². Coating thickness of an undercoat-nickel plating layer is 0.05 μm or larger and 1.0 μm or smaller. If it is smaller than 0.05 μm, nickel content of (Cu, Ni)₆Sn₅ alloy is small and precipitous asperity cannot be formed on a copper-tin alloy layer. If it exceeds 1.0 μm, it is difficult to carry out bending or the like.

In copper plating, an ordinary copper-plating bath can be used; for example, a copper-sulfate plating bath or the like containing copper sulfate (CuSO₄) and sulfuric acid (H₂SO₄) as major ingredients can be used. Temperature of plating bath is set to 20 to 50° C., and current density is set to 1 to 30 A/dm₂. A coating thickness of the copper-plating layer made by this copper plating is set to 0.05 μm or larger and 0.20 μm or smaller. If it is smaller than 0.05 μm, nickel content of (Cu, Ni)₆Sn₅ alloy is large and a shape of a copper-tin alloy layer is too fine. If it exceeds 0.20 μm, the nickel content of (Cu, Ni)₆Sn₅ alloy is small, so that the precipitous asperity is not formed on the copper-tin alloy layer.

As a plating bath for making the tin-plating layer, an ordinary tin-plating bath can be used; for example, a sulfate bath containing sulfuric acid (H₂SO₄) and stannous sulfate (SnSO₄) as major ingredients can be used. Temperature of the plating bath is set to 15 to 35° C., and current density is set to 1 to 30 A/dm². A coating thickness of the tin-plating layer is set to 0.5 μm or larger and 1.0 μm or smaller. If the thickness of the tin-plating layer is smaller than 0.5 μm, the tin-based surface layer is thin after reflowing, so that the electrical connection-characteristic is deteriorated; or if it exceeds 1.0 μm, the surface layer part cannot be the composite structure of tin and copper-tin alloy, so that it is difficult to suppress the friction coefficient to 0.3 or lower.

As the condition for the reflow treatment, the base material is heated for 1 second or longer and 12 seconds or shorter in a reduction atmosphere under a condition of surface temperature is 240° C. or higher and 360° C. or lower, and then the base material is rapidly cooled. It is more preferable to rapid cool after heating 260° or higher and 300° C. or lower for 5 seconds or longer and 10 seconds or shorter. In this case, it is appropriate for holding in a range of 1 second or longer and 12 seconds or shorter in accordance with thicknesses of the copper-plating layer and the tin-plating layer. The holding time is shorter if the plating thickness is thinner; and the longer holding time is necessitated if it is thicker.

<The Holding Time after Raising the Temperature of the Base Material to 240° C. Or Higher and 360° C. Or Lower>
(1) When the thickness of the tin-plating layer is 0.5 μm or larger and smaller than 0.7 μm:

1 second or longer and 6 seconds or shorter if the thickness of the copper-plating layer is 0.05 μm or larger and smaller than 0.16 μm; or

3 seconds or longer and 9 seconds or shorter if the thickness of the copper-plating layer is 0.16 μm or larger and 0.20 μm or smaller.

(2) When the thickness of the tin-plating layer is 0.7 μm or larger and 1.0 μm or smaller:

3 seconds or longer and 9 seconds or shorter if the thickness of the copper-plating layer is 0.05 μm or larger and smaller than 0.16 μm; or

6 seconds or longer and 12 seconds or shorter if the thickness of the copper-plating layer is 0.16 μm or larger and 0.20 μm or smaller.

When the temperature is lower than 240° C. and the holding time is shorter than the time shown in the above (1) and (2), fusion of tin does not proceed. When the temperature exceeds 360° C. and the holding time exceeds the time shown in the above (1) and (2), crystals of copper-tin alloy layer grow too large, so that the desired shape cannot be obtained; and further, the tin-based surface layer cannot remain since the copper-tin alloy layer reaches to the surface layer. Moreover, if the heating condition is intense, it is not desirable since the tin-based surface layer is oxidized.

Degreasing, acid cleaning and the like on raw material after reflowing, and then a nickel plating for a coating layer is carried out on a surface after purifying. An ordinary nickel-plating bath can be used for nickel plating; for example, nickel chloride bath containing hydrochloric acid (HCl) and nickel chloride (NiCl₂) as major ingredients can be used. Temperature of the nickel-plating bath is set to 15° C. or higher and 35° C. or lower; and current density is set to 1 A/dm² or higher and 10 A/dm² or lower. The nickel-based coating layer is obtained with the coating thickness of 0.005 μm or larger and 0.05 μm or smaller as described above.

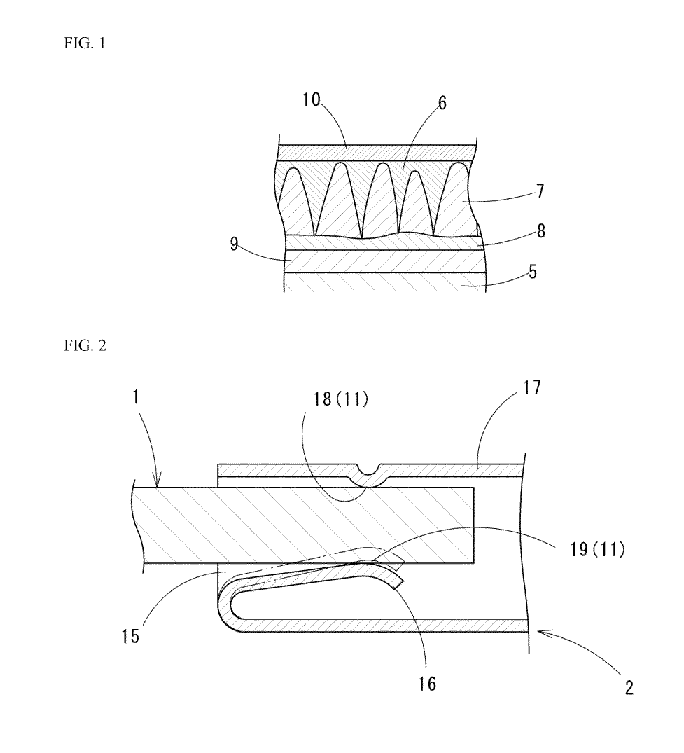

The terminal material is formed into a female terminal 2 of a shape shown in FIG. 2, for example.

In the example shown in FIG. 2, the female terminal 2 is formed to have a square-pipe shape as a whole so that the male terminal 1 is fit-inserted from an opening part 15 formed at one end of the female terminal 2. The female terminal 2 holds the male terminal 1 by grasping from both sides and is connected to the male terminal 1. In the female terminal 2, an elastically-deformable contact piece 16 which contacts with one surface of the male terminal 1 which is fit-inserted is provided; and on a side wall 17 opposed to the contact piece 16, a semi-spherical protrusion part 18 is formed in an inwardly protruded state by embossing so as to be in contact with the other surface of the male terminal 1. On the contact piece 16, a folded part 19 is formed in a mountain-fold state so as to be opposed to the protrusion part 18. The protrusion part 18 and the folded part 19 are protruded toward the male terminal 1 when the male terminal 1 is fit-inserted so as to be sliding parts 11 on the male terminal 1.

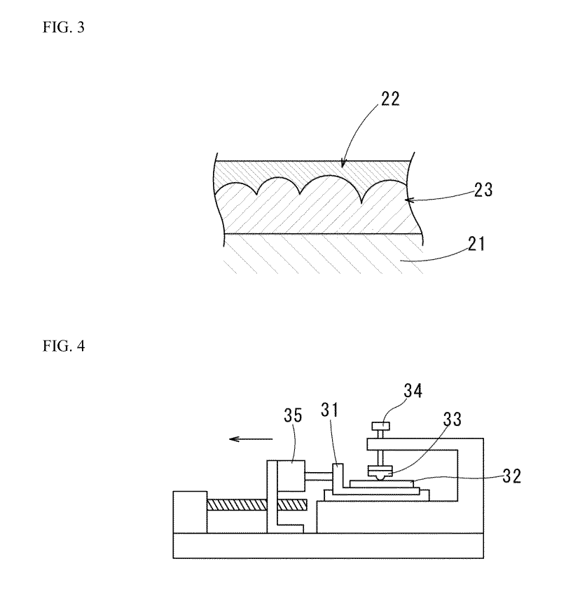

The terminal material used for the male material 1 is, as schematically shown by FIG. 3, formed from an ordinary reflow-treatment material in which a tin-plating layer 22 is formed on a surface of a base material 21 made from copper alloy, and a copper-tin alloy layer 23 is formed between the tin-plating layer 22 and the copper-alloy base material 21. In this male terminal 1, an average gap “S” of the point peaks of the copper-tin alloy layer 23 is measured smaller than 0.8 μm or larger than 2.0 μm when the tin-plating layer 22 is fused and removed so that the copper-tin alloy layer 23 appears on a surface; and the average thickness of the tin-plating layer 22 is 0.2 μm or larger and 3 μm or smaller.

The male terminal 1 is formed in a flat-plate shape, by reflowing after copper plating and tin plating in order on a copper-alloy plate. In this case, as typical heating condition of reflowing, it is rapidly cooled after being held at temperature of 240° C. or higher and 400° C. or lower for 1 second or longer and 20 seconds or shorter.

Terminal material can be made for male-terminal material without reflowing but forming a tin-plating layer having an average thickness of 0.5 μm or larger and 3 μm or smaller by tin plating on a base material of copper alloy.

In connectors made from these female-terminal material and male-terminal material, the contact piece 16 is elastically deformed to a position indicated by a solid line from a position indicated by a two-dot and dashed line when the male terminal 1 is inserted between the contact piece 16 and the side wall 17 through the opening part 15 of the female terminal 2, so that the male terminal 1 is held by being grasped between the folded part 19 and the protrusion part 18.

As described above, the female terminal 2 is formed so that: the interface between the copper-tin alloy layer 7 and the tin-based surface layer 6 has the precipitous asperity with the average gap “S” between the point peaks of the copper-tin alloy layer 7 of 0.8 μm or larger and 2.0 μm or smaller; the average thickness of the tin-based surface layer 6 is 0.1 μm or larger and 0.6 μm or smaller; and the nickel-based coating layer 10 with the coating thickness of 0.005 μm or larger and 0.05 μm or smaller is formed at the outermost surface of the tin-based surface layer 6. Therefore, the adhesion of tin to the surfaces of the protrusion part 18 and the folded part 19 of the female terminal 2 can be prevented, the reduction effect of the dynamic friction coefficient is effective since the precipitous asperity is formed at the interface between the copper-tin alloy layer 7 and the tin-based surface layer 6, and the dynamic friction coefficient can be reduced to 0.3 or lower even though the male terminal 1 has a tin-based surface layer by an ordinal reflow treatment.

In the above embodiment, the nickel-based coating layer 10 which is made from nickel or nickel alloy is formed on the tin-based surface layer 6, however, a cobalt-based coating layer made from cobalt (Co) or cobalt alloy (cobalt-tin (Co—Sn) alloy) can be alternative to the nickel-based coating layer 10.

The cobalt-based coating layer is formed mainly on the exposed portions of the copper-tin alloy layer exposed from the tin-based surface layer after reflowing, as the nickel-based coating layer. Cobalt in the cobalt-based coating layer is easier to be alloyed comparing with nickel in the nickel-based coating layer. A coating thickness of the cobalt-based coating layer is 0.005 μm or larger and 0.05 μm or smaller. If the coating thickness is larger than 0.05 μm, the reduction effect of friction coefficient by the specific shape of the interface between the tin-based surface layer and the copper-tin alloy layer and the restriction effect of tin-adhesion by the cobalt-based coating layer cannot be obtained at the same time; furthermore, the reduction effect of friction coefficient is not enough since only the restriction effect of adhesion of tin by the cobalt-based coating layer is obtained, and the soldering wettability is deteriorated. The effects cannot be obtained if it is smaller than 0.005 μm.

Although the cobalt-based coating layer is formed mainly on the exposed portions of the copper-tin alloy layer exposed from the tin-based surface layer as the nickel-based coating layer, some of the exposed portions of the copper-tin alloy layer in a state of being exposed without being coated by the cobalt-based coating layer. Accordingly, the uppermost surface is a surface in which the tin-based surface layer, the cobalt-based coating layer, and the copper-tin alloy layer are mixed.

If the cobalt-based coating layer is not formed on the exposed portions of the copper-tin alloy layer but is formed only on the tin-based surface layer, in an early stage of using as a connector, the cobalt-based coating layer is broken by abrasion between the terminal materials. As a result, adhesion of tin owing to contact of tin of the same kind with each other is easy to occur, so that it is difficult to maintain the reduction effect of the friction coefficient.

In order to form the cobalt-based coating layer, degreasing, the surface is purified by acid cleaning and the like out on raw material after reflowing treatment, cobalt plating for a coating layer is carried out. An ordinary cobalt-plating bath can be used for cobalt plating, for example, cobalt sulfate bath or the like containing cobalt sulfate (CoSO₄), boric acid (H₃BO₃), and sodium sulfate (NaSO₄) as major ingredients can be used. Temperature of the cobalt-plating bath is set to 15° C. or higher and 35° C. or lower; and current density is set to 0.1 A/dm² or higher and 10 A/dm² or lower. The coating thickness of the cobalt-plating layer is set to 0.005 μm or larger and 0.05 μm or smaller.

### Examples

Test materials were made from base material of an oxygen-free copper plate having a plate thickness of 0.25 mm, by carrying out the undercoat-nickel plating, copper plating, and tin plating in order. The plating conditions of the copper plating and the tin plating were the same for Comparative Examples and the Examples. After plating, the base material was reflowed by heating to a state in which surface temperature of the base material was to 240° C. or higher and 360° C. or lower, holding for 1 second or longer and 12 seconds or shorter, and then water cooling for the test materials of Examples and Comparative Examples. After reflowing, plating was carried out for the nickel-based coating layer or the cobalt-based coating layer.

As Comparative Examples, test materials having the different thicknesses of the undercoat-nickel plating, the copper plating, and the tin plating, and test materials on which plating for the nickel-based coating layer or the cobalt-based coating layer was not carried out were formed.

The conditions of plating are shown in Table 1. In Table 1, “Dk” denotes current density of a cathode, and “ASD” is an abbreviation of A/dm².

Thicknesses and reflowing conditions of the plating layers are shown in Tables 2-1 and 2-2.

TABLE 1

| | | | | | | | | | COBALT-BASED | |
|---|---|---|---|---|---|---|---|---|---|---|
| | UNDERCOAT- | | COPPER | | | | NICKEL-BASED | | COATING | |
| | NICKEL PLATING | | PLATING | | TIN PLATING | | COATING LAYER | | LAYER | |
| COMPOSITION | NICKEL | 300 g/L | COPPER | 250 g/L | TIN | 75 g/L | NICKEL | 240 g/L | COBALT | 15 g/L |
| OF PLATING | SULFATE | | SULFATE | | SULFATE | | CHLORIDE | | SULFATE | |
| SOLUTION | SULFRIC | 2 g/L | SULFRIC | 50 g/L | SULFRIC | 85 g/L | HYDROCHLORIC | 50 g/L | BORIC | 1 g/L |
| | ACID | | ACID | | ACID | | ACID | | ACID | |
| | | | | | ADDITIVE | 10 g/L | | | SODIUM | 16 g/L |
| | | | | | | | | | SULFATE | |

| | | | | | |
|---|---|---|---|---|---|
| LIQUID | 50° C. | 25° C. | 25° C. | 25° C. | 25° C. |
| TEMPERATURE | | | | | |
| Dk | 5 ASD | 5 ASD | 5 ASD | 2 ASD | 1 ASD |

Regarding each of the test materials, the thickness of the tin-based surface layer, the thicknesses of the copper-tin alloy layer, the nickel content of (Cu, Ni)₆Sn₅, existence of a layer of (Ni, Cu)₃Sn₄, the average gap “S” between the point peaks of the copper-tin alloy layer, the thickness of the nickel-based coating layer or the cobalt-based coating layer, the dynamic friction coefficient, and the soldering wettability were evaluated.

The thickness of the nickel-based coating layer or the cobalt-based coating layer, and the thickness of the tin-based surface layer and the copper-tin alloy layer after reflowing were measured by fluorescent X-ray gauge (SFT 9400) made by SII Nano Technology Inc. Regarding the thicknesses of the tin-based surface layer and the copper-tin alloy layer after reflowing, at first, thickness of the whole tin-based surface layer of the test material before forming the nickel-based coating layer was measured after reflowing. Next, removing the tin-based surface layer by soaking for 5 minutes in etchant for removing a plating coat which etches pure tin but do not corrode the copper-tin alloy such as L80 or the like made by Leybold Co., Ltd., for example, so that the lower copper-tin alloy layer was exposed. Then, a conversion thickness of the exposed copper-tin alloy layer in terms of pure tin was measured. The thickness of the tin-based surface layer was defined by (the thickness of the whole tin-based surface layer—the conversion thickness of the copper-tin alloy layer in terms of pure tin).

The nickel content of (Cu, Ni)₆Sn₅ layer and the existence of (Ni, Cu)₃Sn₄ were obtained from images of cross-sectional STEM (Scanning Transmission Electron Microscope) and analysis by EDS (Energy Dispersive X-ray Spectroscopy).

The average gap “S” between the point peaks of the copper-tin alloy layer were obtained as follows. The tin-based surface layer was removed by soaking in etchant for removing a tin-plating coat so that the under copper-tin alloy layer was exposed. Then, the average gap “S” was obtained by an average of values measured at 5 points in a longitudinal direction and 5 points in a transverse direction, 10 points in total, by a laser microscope (VK-X200) made by Keyence Corporation with an object lens having a magnification of 150 (a measuring field 94 μm×70 μm).

Regarding the dynamic friction coefficient, simulating contact portions of the male terminal and the female terminal in a fit-type connector, test pieces of the male terminal with a plate-shape and test pieces of the female terminal with a half-spherical shape of an inner diameter of 1.5 mm are made from the test materials. The dynamic friction coefficient was obtained by measuring friction force between both the test pieces by a friction measuring instrument (μV1000) made by Trinity-Lab Inc. Explaining with reference to FIG. 4, a male-terminal test piece 32 was mounted on a horizontal stage 31; plating surfaces were in contact with each other by arranging a semi-spherical protrusion face of a female-terminal test piece 33 on the male-terminal test piece 32; so that the male-terminal test piece 32 was pressed down by applying a load “P” of 100 gf or larger and 500 gf or smaller on the female-terminal test piece 33 by a weight 34. In a state in which the load “P” was applied, the male-terminal test piece 32 was drawn for 10 mm at 80 mm/min of frictional speed in a horizontal direction indicated by an arrow; and friction force “F” was measured by a load cell 35. The dynamic friction coefficient (=Fav/P) was obtained from an average value “Fav” of the friction force “F” and the load “P”. The dynamic friction coefficient when the load “P” was 4.9 N (500 gf) was shown in Tables 2-1 to 2-3.

The test pieces of male terminals were formed as follows. On a copper-alloy plate having a plate thickness of 0.25 mm (C2600, copper: 70 mass %-zinc: 30 mass %) as a base material, copper plating and tin plating were carried out in order, and then reflowing was carried out on a condition in which temperature of the base material was 270° C. and a holding time was 6 seconds, so that the thickness of the tin-plating layer was 0.6 μm and the thickness of the copper-tin alloy layer was 0.5 μm after reflowing, and the average gap “S” between the point peaks of the copper-tin alloy layer was 2.1 μm. Dynamic friction coefficient was measured by using the male-terminal test piece and the female-terminal test pieces in Tables 2-1 to 2-3.

With respect to the soldering wettability, zero-crossing time was measured on the test piece cut off with 10 mm width by the meniscograph method using active flux. (It was measured by soaking in tin-3% silver-0.5% copper solder of bath temperature 230° C. in condition of a soaking rate 2 mm/sec, a soaking depth 1 mm, and a soaking time 10 seconds.) It was judged to be “good” if the soldering zero-cross time was 3 seconds or shorter; and it was judged to be “poor” if the soldering zero-cross time exceeded 3 seconds.

In order to evaluate electrical reliability, contact resistance was measured after heating at 150° C. for 500 hours in the atmosphere. Measuring method was conformed to JIS-C-5402, using a four-terminal contact-resistance test instrument (CRS-113-AU made by Yamasaki-Seiki Co., Ltd), measuring load variation-contact resistance at 0 to 50 g by sliding (1 mm), and the contact resistance values were evaluated when the load was 50 g.

Results of the measurement and the evaluation were shown in Tables 2-1 to 2-3 for the test pieces in which the nickel-based coating layers were formed, and shown in Tables 3-1 to 3-3 for the test pieces in which the cobalt-based coating layers were formed.

TABLE 2-1

| | | EXAMPLE | | | | | | | | | |
|---|---|---|---|---|---|---|---|---|---|---|---|
| | | 1 | 2 | 3 | 4 | 5 | 6 | 7 | 8 | 9 | 10 |
| COATING THICKNESS OF | Ni | 0.32 | 0.32 | 0.32 | 0.32 | 0.32 | 0.30 | 0.28 | 0.30 | 0.05 | 0.18 |
| PLATING LAYER | Cu | 0.15 | 0.15 | 0.15 | 0.15 | 0.15 | 0.15 | 0.05 | 0.20 | 0.10 | 0.15 |
| (μm) | Sn | 0.96 | 0.96 | 0.96 | 0.96 | 0.96 | 0.80 | 0.62 | 0.57 | 0.81 | 0.91 |

| | | | | | | | | | | | |
|---|---|---|---|---|---|---|---|---|---|---|---|
| REFLOW | MATERIAL | 270 | 270 | 270 | 270 | 270 | 270 | 245 | 270 | 270 | 270 |
| CONDITION | TEMPERATURE | | | | | | | | | | |
| | (° C.) | | | | | | | | | | |
| | HOLDING TIME (s) | 6 | 6 | 6 | 6 | 6 | 6 | 3 | 9 | 6 | 6 |

| | | | | | | | | | | | |
|---|---|---|---|---|---|---|---|---|---|---|---|
| LAYER THICKNESS AFTER | Sn | 0.46 | 0.46 | 0.46 | 0.46 | 0.46 | 0.38 | 0.27 | 0.24 | 0.33 | 0.45 |
| REFLOWING (μm) | CuSn | 0.76 | 0.76 | 0.76 | 0.76 | 0.76 | 0.74 | 0.63 | 0.41 | 0.73 | 0.70 |

| | | | | | | | | | | |
|---|---|---|---|---|---|---|---|---|---|---|
| COATING THICKNESS OF NICKEL- | 0.01 | 0.01 | 0.02 | 0.03 | 0.05 | 0.01 | 0.01 | 0.01 | 0.01 | 0.01 |
| BASED COATING LAYER (μm) | | | | | | | | | | |
| Ni CONTENT OF (Cu, Ni)₆Sn₅ (at %) | 10 | 10 | 10 | 10 | 10 | 9 | 19 | 2 | 8 | 6 |
| EXISTENCE OF (Ni, Cu)₃Sn₄ | YES | YES | YES | YES | YES | YES | YES | YES | YES | YES |
| AVERAGE GAP “S” BETWEEN | 1.12 | 1.12 | 1.12 | 1.12 | 1.12 | 0.97 | 0.82 | 1.87 | 0.97 | 1.23 |
| POINT PEAKS OF COPPER-TIN | | | | | | | | | | |
| ALLOY LAYER (μm) | | | | | | | | | | |
| DYNAMIC FRICTION COEFFICIENT | 0.26 | 0.21 | 0.22 | 0.22 | 0.23 | 0.23 | 0.22 | 0.24 | 0.26 | 0.25 |
| LOAD 500 gf | | | | | | | | | | |
| SOLDERING WETTABILITY | GOOD | GOOD | GOOD | GOOD | GOOD | GOOD | GOOD | GOOD | GOOD | GOOD |
| CONTACT RESISTANCE (mΩ) | 1.44 | 1.52 | 1.87 | 2.05 | 2.39 | 1.52 | 3.01 | 3.44 | 5.23 | 3.69 |

TABLE 2-2

| | | EXAMPLE | | | | | | | | |
|---|---|---|---|---|---|---|---|---|---|---|
| | | 11 | 12 | 13 | 14 | 15 | 16 | 17 | 18 | 19 |
| COATING THICKNESS OF | Ni | 0.97 | 0.31 | 0.30 | 0.29 | 0.31 | 0.27 | 0.28 | 0.28 | 0.31 |
| PLATING LAYER | Cu | 0.15 | 0.10 | 0.15 | 0.15 | 0.15 | 0.05 | 0.20 | 0.15 | 0.10 |
| (μm) | Sn | 0.90 | 0.91 | 0.92 | 0.90 | 0.89 | 0.52 | 0.92 | 0.64 | 0.98 |

| | | | | | | | | | | |
|---|---|---|---|---|---|---|---|---|---|---|
| REFLOW | MATERIAL | 270 | 270 | 270 | 250 | 350 | 245 | 270 | 245 | 360 |
| CONDITION | TEMPERATURE | | | | | | | | | |
| | (° C.) | | | | | | | | | |
| | HOLDING TIME (s) | 6 | 3 | 9 | 6 | 6 | 3 | 12 | 6 | 12 |

| | | | | | | | | | | |
|---|---|---|---|---|---|---|---|---|---|---|
| LAYER THICKNESS AFTER | Sn | 0.43 | 0.44 | 0.26 | 0.44 | 0.29 | 0.21 | 0.32 | 0.24 | 0.49 |
| REFLOWING (μm) | CuSn | 0.71 | 0.71 | 0.92 | 0.72 | 0.81 | 0.45 | 0.90 | 0.60 | 0.83 |

| | | | | | | | | | |
|---|---|---|---|---|---|---|---|---|---|
| COATING THICKNESS OF NICKEL- | 0.01 | 0.01 | 0.01 | 0.01 | 0.01 | 0.01 | 0.01 | 0.01 | 0.01 |
| BASED COATING LAYER (μm) | | | | | | | | | |
| Ni CONTENT OF (Cu, Ni)₆Sn₅ (at %) | 18 | 8 | 9 | 9 | 14 | 24 | 3 | 9 | 18 |
| EXISTENCE OF (Ni, Cu)₃Sn₄ | YES | YES | YES | YES | YES | YES | YES | YES | YES |
| AVERAGE GAP “S” BETWEEN | 1.10 | 1.02 | 1.16 | 1.03 | 1.20 | 0.87 | 1.28 | 1.42 | 1.36 |
| POINT PEAKS OF COPPER-TIN | | | | | | | | | |
| ALLOY LAYER (μm) | | | | | | | | | |
| DYNAMIC FRICTION COEFFICIENT | 0.21 | 0.27 | 0.25 | 0.24 | 0.24 | 0.22 | 0.25 | 0.28 | 0.26 |
| LOAD 500 gf | | | | | | | | | |
| SOLDERING WETTABILITY | GOOD | GOOD | GOOD | GOOD | GOOD | GOOD | GOOD | GOOD | GOOD |
| CONTACT RESISTANCE (mΩ) | 1.62 | 2.26 | 3.11 | 2.41 | 2.89 | 3.76 | 3.04 | 3.28 | 2.89 |

TABLE 2-3

| | | COMPARATIVE EXAMPLE | | | | | | | | |
|---|---|---|---|---|---|---|---|---|---|---|
| | | 1 | 2 | 3 | 4 | 5 | 6 | 7 | 8 | 9 |
| COATING THICKNESS OF | Ni | 0.02 | 0.02 | 0.32 | 0.32 | 0.28 | 0.34 | 0.29 | 0.29 | 0.31 |
| PLATING LAYER | Cu | 0.15 | 0.15 | 0.15 | 0.15 | 0.03 | 0.20 | 0.30 | 0.15 | 0.15 |
| (μm) | Sn | 0.93 | 0.93 | 0.96 | 0.96 | 0.94 | 0.40 | 0.80 | 0.35 | 0.92 |

| | | | | | | | | | | |
|---|---|---|---|---|---|---|---|---|---|---|
| REFLOW | MATERIAL | 270 | 270 | 270 | 270 | 270 | 270 | 270 | 270 | 270 |
| CONDITION | TEMPERATURE (° C.) | | | | | | | | | |
| | HOLDING TIME (s) | 6 | 6 | 6 | 6 | 3 | 6 | 6 | 3 | 12 |

| | | | | | | | | | | |
|---|---|---|---|---|---|---|---|---|---|---|
| LAYER THICKNESS AFTER | Sn | 0.51 | 0.51 | 0.46 | 0.46 | 0.44 | 0.12 | 0.31 | 0.01 | 0.06 |
| REFLOWING (μm) | CuSn | 0.55 | 0.55 | 0.80 | 0.75 | 0.77 | 0.41 | 0.61 | 0.48 | 1.00 |

| | | | | | | | | | |
|---|---|---|---|---|---|---|---|---|---|
| COATING THICKNESS OF NICKEL- | 0 | 0.01 | 0 | 0.07 | 0.01 | 0.01 | 0.01 | 0.01 | 0.01 |
| BASED COATING LAYER (μm) | | | | | | | | | |
| Ni CONTENT OF (Cu, Ni)₆Sn₅ (at %) | 0.5 | 0.5 | 10 | 10 | 27 | 3 | 0 | 6 | 6 |
| EXISTENCE OF (Ni, Cu)₃Sn₄ | NO | NO | YES | YES | YES | YES | NO | YES | YES |
| AVERAGE GAP “S” BETWEEN | 1.42 | 0.42 | 1.11 | 1.11 | 0.72 | 2.37 | 2.08 | 1.73 | 1.66 |
| POINT PEAKS OF COPPER-TIN | | | | | | | | | |
| ALLOY LAYER (μm) | | | | | | | | | |
| DYNAMIC FRICTION COEFFICIENT | 0.42 | 0.34 | 0.35 | 0.27 | 0.34 | 0.27 | 0.34 | 0.27 | 0.29 |
| LOAD 500 gf | | | | | | | | | |
| SOLDERING WETTABILITY | GOOD | GOOD | GOOD | POOR | GOOD | POOR | GOOD | POOR | POOR |
| CONTACT RESISTANCE (mΩ) | 5.11 | 5.76 | 1.58 | 7.52 | 3.24 | 9.66 | 2.42 | 7.21 | 10.96 |

TABLE 3-1

| | | EXAMPLE | | | | | | | | |
|---|---|---|---|---|---|---|---|---|---|---|
| | | 21 | 22 | 23 | 24 | 25 | 26 | 27 | 28 | 29 |
| COATING THICKNESS OF | Ni | 0.33 | 0.33 | 0.33 | 0.33 | 0.3 | 0.29 | 0.32 | 0.06 | 0.18 |
| PLATING LAYER | Cu | 0.15 | 0.15 | 0.15 | 0.15 | 0.15 | 0.05 | 0.20 | 0.10 | 0.15 |
| (μm) | Sn | 0.96 | 0.96 | 0.96 | 0.96 | 0.81 | 0.60 | 0.61 | 0.79 | 0.90 |

| | | | | | | | | | | |
|---|---|---|---|---|---|---|---|---|---|---|
| REFLOW | MATERIAL | 270 | 270 | 270 | 270 | 270 | 245 | 270 | 270 | 270 |
| CONDITION | TEMPERATURE (° C.) | | | | | | | | | |
| | HOLDING TIME (s) | 6 | 6 | 6 | 6 | 6 | 3 | 9 | 6 | 6 |

| | | | | | | | | | | |
|---|---|---|---|---|---|---|---|---|---|---|
| LAYER THICKNESS AFTER | Sn | 0.46 | 0.46 | 0.46 | 0.46 | 0.40 | 0.27 | 0.24 | 0.33 | 0.44 |
| REFLOWING (μm) | CuSn | 0.77 | 0.77 | 0.77 | 0.77 | 0.72 | 0.63 | 0.42 | 0.72 | 0.68 |

| | | | | | | | | | |
|---|---|---|---|---|---|---|---|---|---|
| COATING THICKNESS OF COBALT- | 0.005 | 0.01 | 0.03 | 0.05 | 0.01 | 0.01 | 0.01 | 0.01 | 0.01 |
| BASED COATING LAYER (μm) | | | | | | | | | |
| Ni CONTENT OF (Cu, Ni)₆Sn₅ (at %) | 11 | 11 | 11 | 11 | 10 | 19 | 2 | 5 | 7 |
| EXISTENCE OF (Ni, Cu)₃Sn₄ | YES | YES | YES | YES | YES | YES | YES | YES | YES |
| AVERAGE GAP “S” BETWEEN | 1.14 | 1.14 | 1.14 | 1.14 | 1.02 | 0.86 | 1.89 | 1.03 | 1.27 |
| POINT PEAKS OF COPPER-TIN | | | | | | | | | |
| ALLOY LAYER (μm) | | | | | | | | | |
| DYNAMIC FRICTION COEFFICIENT | 0.26 | 0.24 | 0.23 | 0.22 | 0.24 | 0.25 | 0.24 | 0.26 | 0.25 |
| LOAD 500 gf | | | | | | | | | |
| SOLDERING WETTABILITY | GOOD | GOOD | GOOD | GOOD | GOOD | GOOD | GOOD | GOOD | GOOD |
| CONTACT RESISTANCE (mΩ) | 1.30 | 1.35 | 1.85 | 2.37 | 1.43 | 3.00 | 3.26 | 5.22 | 3.58 |

TABLE 3-2

| | | EXAMPLE | | | | | | | | |
|---|---|---|---|---|---|---|---|---|---|---|
| | | 30 | 31 | 32 | 33 | 34 | 35 | 36 | 37 | 38 |
| COATING THICKNESS OF | Ni | 0.97 | 0.31 | 0.3 | 0.29 | 0.3 | 0.31 | 0.29 | 0.26 | 0.31 |
| PLATING LAYER | Cu | 0.15 | 0.10 | 0.15 | 0.15 | 0.15 | 0.05 | 0.20 | 0.15 | 0.10 |
| (μm) | Sn | 0.90 | 0.91 | 0.91 | 0.88 | 0.91 | 0.50 | 0.84 | 0.61 | 1.00 |

| | | | | | | | | | | |
|---|---|---|---|---|---|---|---|---|---|---|
| REFLOW | MATERIAL | 270 | 270 | 270 | 250 | 350 | 245 | 270 | 245 | 360 |
| CONDITION | TEMPERATURE (° C.) | | | | | | | | | |
| | HOLDING TIME (s) | 6 | 3 | 9 | 6 | 6 | 3 | 12 | 6 | 12 |

| | | | | | | | | | | |
|---|---|---|---|---|---|---|---|---|---|---|
| LAYER THICKNESS AFTER | Sn | 0.43 | 0.43 | 0.24 | 0.43 | 0.30 | 0.21 | 0.24 | 0.23 | 0.56 |
| REFLOWING (μm) | CuSn | 0.68 | 0.69 | 0.87 | 0.72 | 0.80 | 0.44 | 0.78 | 0.61 | 0.87 |

| | | | | | | | | | |
|---|---|---|---|---|---|---|---|---|---|
| COATING THICKNESS OF COBALT- | 0.01 | 0.01 | 0.01 | 0.01 | 0.01 | 0.01 | 0.01 | 0.01 | 0.01 |
| BASED COATING LAYER (μm) | | | | | | | | | |
| Ni CONTENT OF (Cu, Ni)₆Sn₅ (at %) | 20 | 5 | 12 | 6 | 14 | 22 | 2 | 9 | 17 |
| EXISTENCE OF (Ni, Cu)₃Sn₄ | YES | YES | YES | YES | YES | YES | YES | YES | YES |
| AVERAGE GAP “S” BETWEEN | 1.16 | 1.08 | 1.21 | 1.06 | 1.21 | 0.93 | 1.31 | 1.44 | 1.37 |
| POINT PEAKS OF COPPER-TIN | | | | | | | | | |
| ALLOY LAYER (μm) | | | | | | | | | |
| DYNAMIC FRICTION COEFFICIENT | 0.22 | 0.28 | 0.24 | 0.26 | 0.25 | 0.24 | 0.25 | 0.27 | 0.25 |
| LOAD 500 gf | | | | | | | | | |
| SOLDERING WETTABILITY | GOOD | GOOD | GOOD | GOOD | GOOD | GOOD | GOOD | GOOD | GOOD |
| CONTACT RESISTANCE (mΩ) | 1.45 | 2.11 | 2.97 | 2.36 | 2.82 | 3.59 | 2.92 | 3.09 | 2.84 |

TABLE 3-3

| | | COMPARATIVE EXAMPLE | | | | | | | | |
|---|---|---|---|---|---|---|---|---|---|---|
| | | 11 | 12 | 13 | 14 | 15 | 16 | 17 | 18 | 19 |
| COATING THICKNESS OF | Ni | 0.02 | 0.02 | 0.33 | 0.33 | 0.32 | 0.31 | 0.3 | 0.29 | 0.29 |
| PLATING LAYER | Cu | 0.15 | 0.15 | 0.15 | 0.15 | 0.02 | 0.20 | 0.30 | 0.15 | 0.15 |
| (μm) | Sn | 0.93 | 0.93 | 0.96 | 0.96 | 0.97 | 0.41 | 0.79 | 0.33 | 0.87 |

| | | | | | | | | | | |
|---|---|---|---|---|---|---|---|---|---|---|
| REFLOW | MATERIAL | 270 | 270 | 270 | 270 | 270 | 270 | 270 | 270 | 270 |
| CONDITION | TEMPERATURE (° C.) | | | | | | | | | |
| | HOLDING TIME (s) | 6 | 6 | 6 | 6 | 3 | 6 | 6 | 3 | 12 |

| | | | | | | | | | | |
|---|---|---|---|---|---|---|---|---|---|---|
| LAYER THICKNESS AFTER | Sn | 0.51 | 0.51 | 0.46 | 0.46 | 0.44 | 0.12 | 0.31 | 0.01 | 0.06 |
| REFLOWING (μm) | CuSn | 0.55 | 0.55 | 0.77 | 0.77 | 0.77 | 0.41 | 0.61 | 0.48 | 1.00 |

| | | | | | | | | | |
|---|---|---|---|---|---|---|---|---|---|
| COATING THICKNESS OF COBALT- | 0 | 0.01 | 0 | 0.09 | 0.01 | 0.01 | 0.01 | 0.01 | 0.01 |
| BASED COATING LAYER (μm) | | | | | | | | | |
| Ni CONTENT OF (Cu, Ni)₆Sn₅ (at %) | 0.5 | 0.5 | 11 | 11 | 27 | 1 | 0 | 4 | 8 |
| EXISTENCE OF (Ni, Cu)₃Sn₄ | NO | NO | YES | YES | YES | YES | NO | YES | YES |
| AVERAGE GAP “S” BETWEEN | 1.49 | 1.46 | 1.14 | 1.12 | 0.79 | 2.39 | 2.12 | 1.75 | 1.69 |
| POINT PEAKS OF COPPER-TIN | | | | | | | | | |
| ALLOY LAYER (μm) | | | | | | | | | |
| DYNAMIC FRICTION COEFFICIENT | 0.4 | 0.33 | 0.32 | 0.26 | 0.37 | 0.26 | 0.35 | 0.26 | 0.29 |
| LOAD 500 gf | | | | | | | | | |
| SOLDERING WETTABILITY | GOOD | GOOD | GOOD | POOR | GOOD | POOR | GOOD | POOR | POOR |
| CONTACT RESISTANCE (mΩ) | 4.88 | 5.57 | 1.25 | 7.50 | 2.95 | 9.43 | 2.29 | 6.87 | 10.85 |

As obvious from Tables 2-1 to 2-3 and Tables 3-1 to 3-3, in all Examples, the dynamic friction coefficient was small as 0.3 or smaller, and it was shown that the soldering wettability was excellent, and the contact resistance was 10 mΩ or lower. Especially, in Examples 1 to 8, 10, and 10 to 19 having the nickel-plating thickness of 0.1 μm or larger, the contact resistance was low as 4 mΩ or lower.

Meanwhile, in Comparative Examples, there were defects as followings. In Comparative Examples 1 and 3, the dynamic friction coefficient was large since the nickel-based coating layer was not formed. In Comparative Examples 11 and 13, the dynamic friction coefficient was large since the cobalt-based coating layer was not formed. In Comparative Example 2, the reduction effect was obtained; however, it was not highly effective since only the nickel plating was carried on but there was no (Ni, Cu)₃Sn₄ layer. Similarly, in Comparative Example 12, there was the reduction effect but it was not highly effective since it was plated with cobalt but there was not a layer of (Ni, Cu)₃Sn₄. In Comparative Example 4, the soldering wettability was deteriorated since the coating thickness of the nickel-based coating layer was large. In Comparative Example 14, the soldering wettability was deteriorated since the coating thickness of the cobalt-based coating layer was large. In Comparative Examples 5 and 15, the dynamic friction coefficient exceeded 0.3 since the copper-plating thickness was too thin and therefore the average gap “S” of the point peaks of the copper-tin alloy layer was smaller than a minimum limit. In Comparative Examples 6, 8, 9, 16, 18, and 19, the copper-tin alloy layer was grown too large, so that the tin-based surface layer which was remained on the surface was too small; accordingly, the soldering wettability was deteriorated. The dynamic friction coefficient exceeded 0.3. In Comparative Examples 7 and 17, a layer of (Ni, Cu)₃Sn₄ was not formed since the copper-plating thickness was too thick and nickel was not contained in Cu₆Sn₅, so that it was not highly effective.

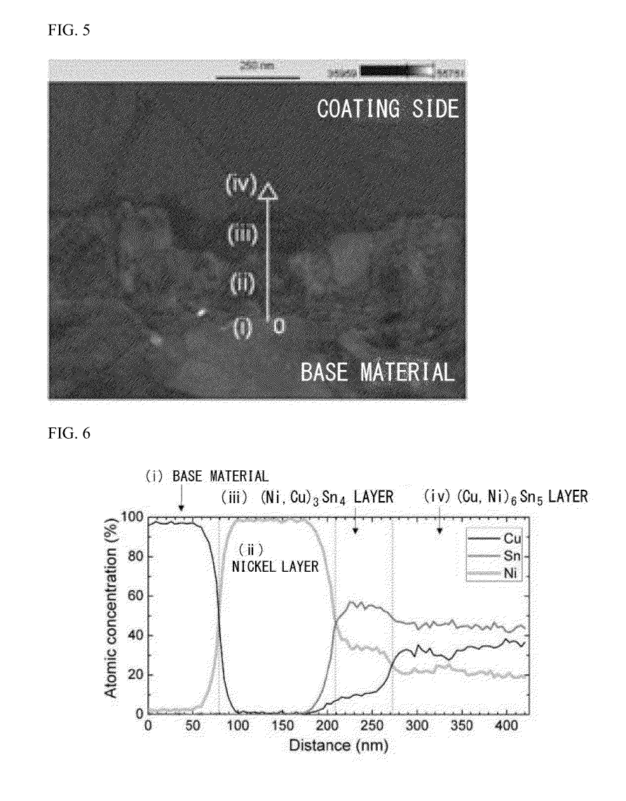

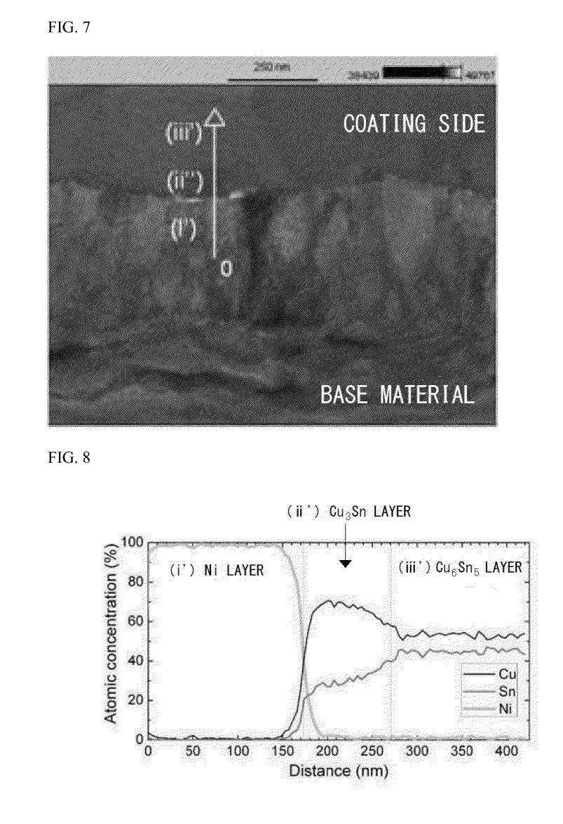

FIGS. 5 and 6 show the image of cross-sectional STEM and the result of analysis of EDS of Example 6. FIGS. 7 and 8 show the image of cross-sectional STEM and the result of analysis of EDS of Example 7. In FIGS. 5 and 6, the reference (i) denotes the base material, the reference (ii) denotes the nickel layer, (iii) denotes the alloy layer of (Ni, Cu)₃Sn₄, and the reference (iv) denotes the alloy layer of (Cu, Ni)₆Sn₅. In FIGS. 7 and 8, the reference (i′) denotes the nickel layer, the reference (ii′) denotes the alloy layer of Cu₃Sn, and the reference (iii′) denotes the alloy layer of Cu₆Sn₅.

Comparing these photographs, it can be recognized that nickel is contained in Cu₆Sn₅ as shown in FIG. 6 and the layer of Ni₃Sn₄ containing copper is formed at the interface between the nickel layer and the layer of Cu₆Sn₅ in Examples. Copper content of the layer of Ni₃Sn₄ of the terminal material of Examples is supposed to be in a range of 5 to 20 at %. For example, it was 11 at % in Example 2.

In Comparative Examples, it can be recognized that the layer of Ni₃Sn₄ was not formed as shown in FIG. 8, and nickel was not contained in Cu₆Sn₅.

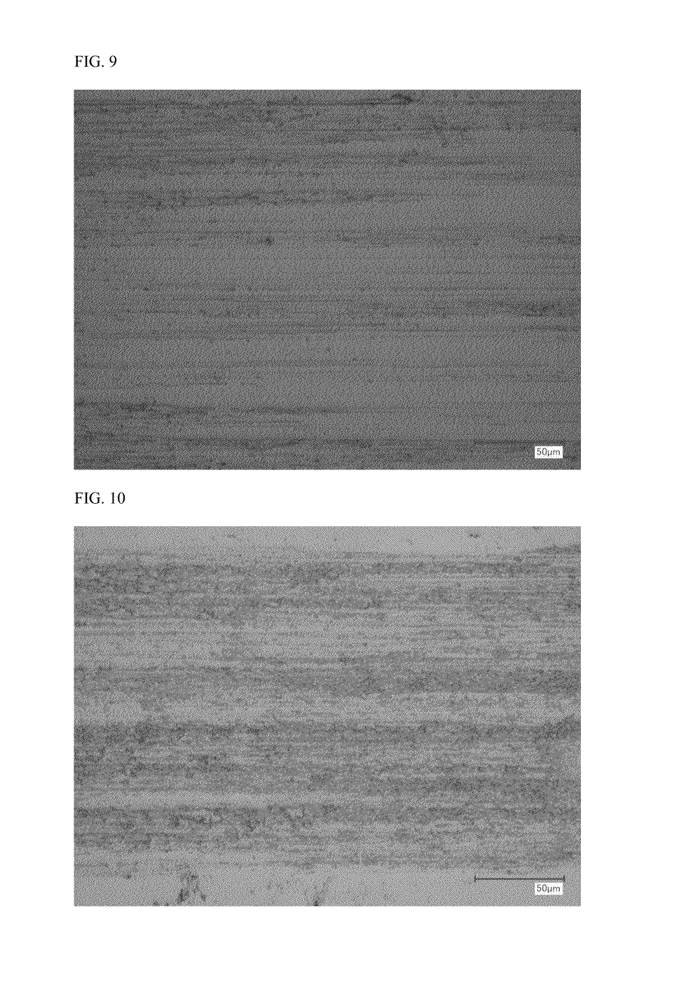

FIG. 9 is a photomicrograph of a sliding surface of the male-terminal test piece of Example 2 after measuring the dynamic friction coefficient. FIG. 10 is a photomicrograph of Comparative Example 1. FIG. 11 is a photomicrograph of Comparative Example 3. It can be recognized by comparing these photographs that: the sliding surface was smooth in Examples since the adhesion of tin was restrained; on the other hand, the sliding surface was rough in Comparative Examples owing to the adhesion of tin. In Comparative Example 7 in which the average gap “S” of the point peaks at the female side was large, the adhesion of tin occurred even though the existence of the nickel-based coating layer, so that the sliding surface was rough.

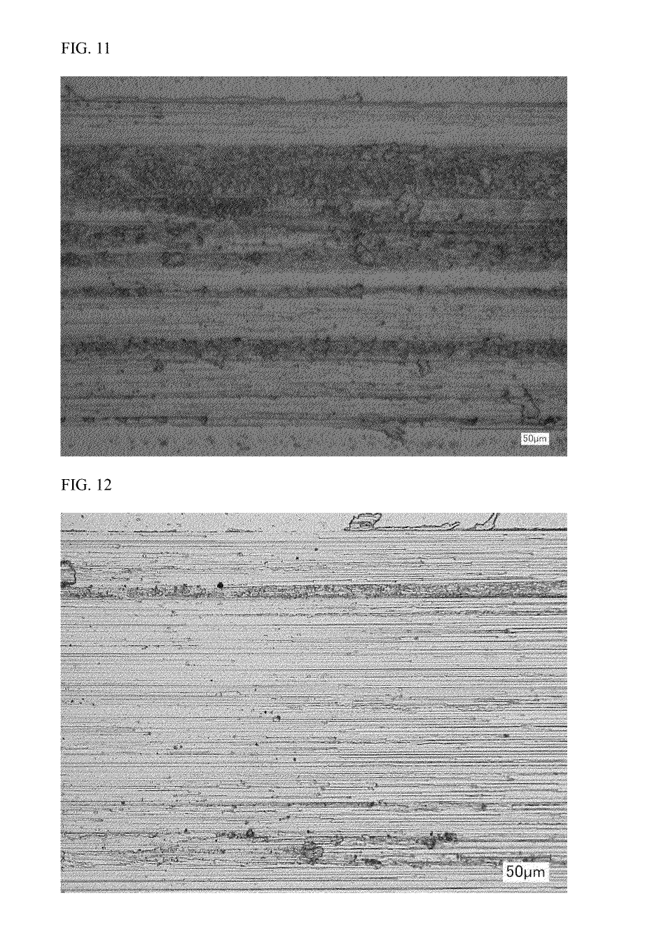

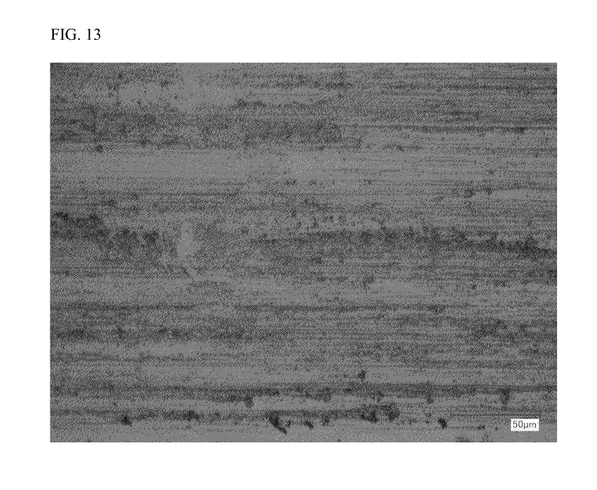

FIG. 12 is a photomicrograph of Example 24. FIG. 13 is a photomicrograph of Comparative Example 13. It can be recognized by comparing these photographs that the sliding surfaces were smooth in Examples with the cobalt-based coating layer since the adhesion of tin was restrained; on the other hand, the sliding surfaces were rough in Comparative Examples without the cobalt-based coating layer owing to the adhesion of tin.

What is claimed is:

1. A tin-plated copper-alloy terminal material comprising:
a base material which is made of copper or copper alloy;
a tin-based surface layer which is formed on a surface of the base material and has an average thickness of 0.2 μm or larger and 0.6 μm or smaller;
a nickel-based coating layer or a cobalt-based coating layer which is formed on an outermost surface of the tin-based surface layer and has a coating thickness of 0.005 μm or larger and 0.05 μm or smaller; and
a copper-tin alloy layer/a nickel-tin alloy layer/a nickel layer or a nickel-alloy layer which are formed between the tin-based surface layer and the base material in order from the tin-based surface layer, wherein
the copper-tin alloy layer is a compound-alloy layer in which a major ingredient is Cu₆Sn₅ and a part of copper of Cu₆Sn₅ is substituted by nickel;
the nickel-tin alloy layer is a compound-alloy layer in which a major ingredient is Ni₃Sn₄ and a part of nickel of Ni₃Sn₄ is substituted by copper;
an average gap “S” of point peaks of the copper-tin alloy layer is 0.8 μm or larger and 2.0 μm or smaller; and
a dynamic friction coefficient at a surface of the tin-plated copper-alloy terminal material is 0.3 or lower.

2. The tin-plated copper-alloy terminal material according to claim 1, wherein
The copper-tin alloy layer is partially exposed from the tin-based surface layer; and
the nickel-based coating layer or the cobalt-based coating layer is formed on the copper-tin alloy layer which is exposed from the tin-based surface layer.

3. The tin-plated copper-alloy terminal material according to claim 1, wherein the copper-tin alloy layer contains 1 at % or more and 25 at % or less of nickel in Cu₆Sn₅.
